(19) United States
(12) Patent Application Publication
(10) Pub. No.: US 2026/0175894 A1
(43) Pub. Date: Jun. 25, 2026

(54) Motorized Stroller Device

(71) Applicant: Joshua Rodriguez, Tacoma, WA (US)

(72) Inventor: Joshua Rodriguez, Tacoma, WA (US)

(21) Appl. No.: 18/987,740

(22) Filed: Dec. 19, 2024

(51) Int. Cl. B62B 7/04; B62B 5/00; B62B 7/00

(52) U.S. Cl. CPC B62B 7/04; B62B 5/0043; B62B 5/0076; B62B 7/008

(57) ABSTRACT

A motorized stroller device for remotely controlling movement of the stroller includes a carriage with a frame and a seat. A pair of rear wheels are rotatably coupled to the frame. Each motor of a pair of electric motors is operatively coupled to a respective rear wheel to selectively rotate the pair of rear wheels. A processor is in communication with the pair of electric motors. A receiver is in communication with the processor. A remote control selectively actuates the pair of electric motors in a first direction, a second direction, and a stationary condition. The remote control includes a directional pad that is selectively positionable to control a direction in which the carriage is being moved. A transceiver sends signals from the remote control to the receiver to selectively actuate the pair of electric motors.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to strollers and more particularly pertains to a new stroller for remotely controlling movement of the stroller.

### (2) Description of Related Art Including Information Disclosed Under 37 CFR 1.97 and 1.98

The prior art relates to strollers. Strollers are often used by families and caregivers with young children, particularly during travel, shopping, sightseeing, and long walks. Many people also use strollers to hold personal items, such as diaper bags and purses. Sometimes, caregivers will even put shopping bags or other items inside the strollers with the young children so that the caregiver can focus on pushing the stroller instead of carrying those personal items. Between the weight of the small children and the weight of the other personal items that are stored within the stroller, the stroller can quickly become quite heavy and difficult to maneuver, especially on steep uphill inclines. Pushing the stroller in such conditions can lead to sore muscles, and even injury, for the caregivers. Accordingly, there is a need for a motorized stroller device that will facilitate the caregivers in moving the strollers without the caregiver needing to physically exert themselves. Ideally, the direction of movement of such a device could be controlled, allowing the caregivers to turn the strollers without physically exerting themselves.

### (h) BRIEF SUMMARY OF THE INVENTION

An embodiment of the disclosure meets the needs presented above by generally comprising a carriage with a frame and a seat that is coupled to the frame. A plurality of wheels are rotatably coupled to the frame to facilitate movement of the carriage. The plurality of wheels generally includes a pair of front wheels and a pair of rear wheels. Each electric motor of a pair of electric motors is operatively coupled to a respective rear wheel of the pair of rear wheels. A processor is in communication with the pair of electric motors. A receiver is in communication with the processor. A remote control is in communication with the receiver to selectively actuate the pair of electric motors in a first direction, a second direction, and a stationary condition. The remote control includes a directional pad that is selectively positionable in a forward direction, a reverse direction, a right direction, a left direction, and a home position to control a direction in which the carriage is being moved. A transmitter is in communication with the directional pad wherein the transmitter sends wireless signals from the remote control to the receiver to actuate each electric motor of the pair of electric motors in an associated one of the first direction, the second direction, and the stationary condition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a motorized stroller device according to an embodiment of the disclosure.

FIG. 2 is a rear view of an embodiment of the disclosure.

FIG. 3 is a detail view of an embodiment of the disclosure.

FIG. 4 is a bottom view of an embodiment of the disclosure.

FIG. 5 is a detail view of an embodiment of the disclosure.

FIG. 6 is a front view of an embodiment of the disclosure.

FIG. 7 is a block diagram view of an embodiment of the disclosure.

FIG. 8 is an in-use view of an embodiment of the disclosure.

FIG. 9 is an in-use view of an embodiment of the disclosure.

### (j) DETAILED DESCRIPTION OF THE INVENTION

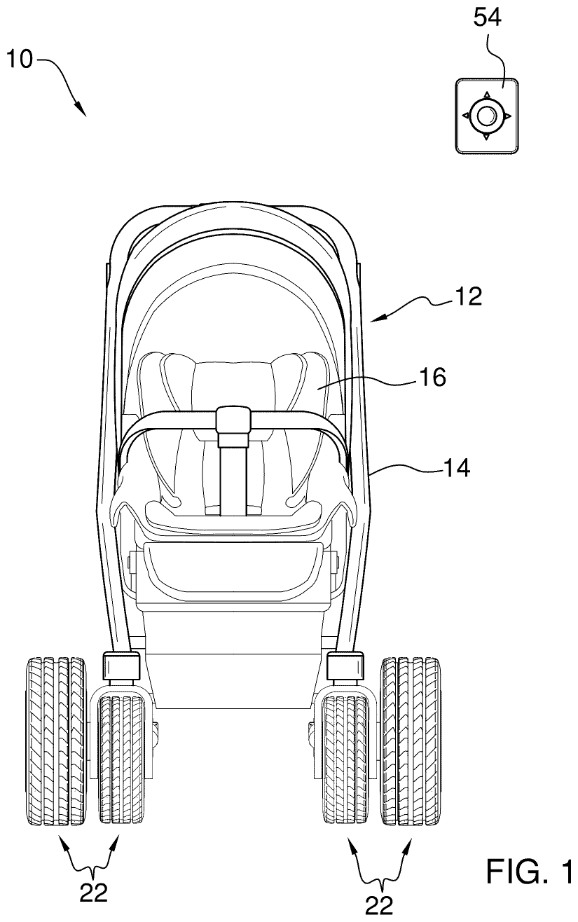

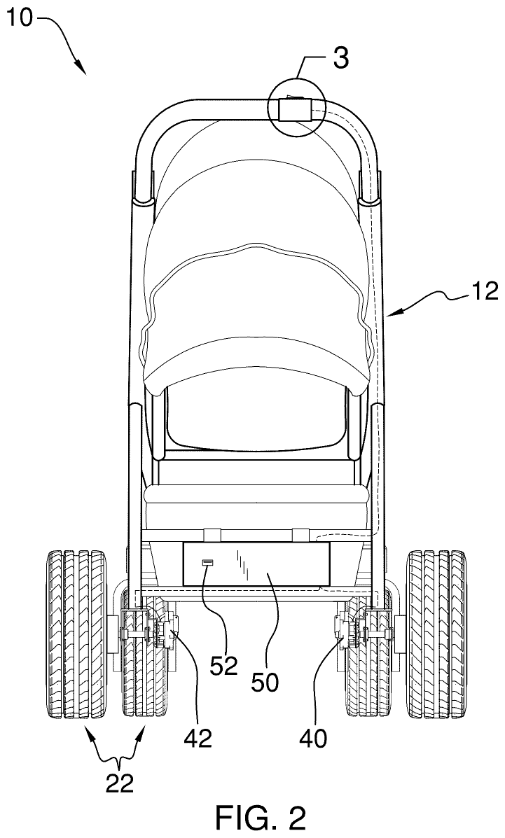

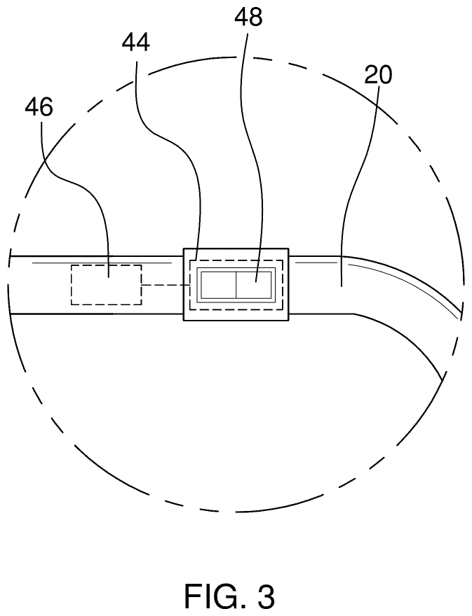

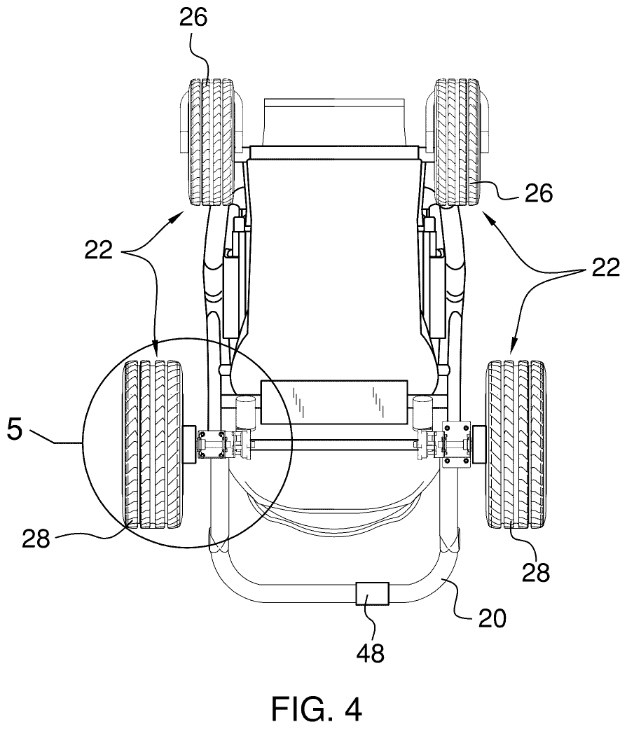

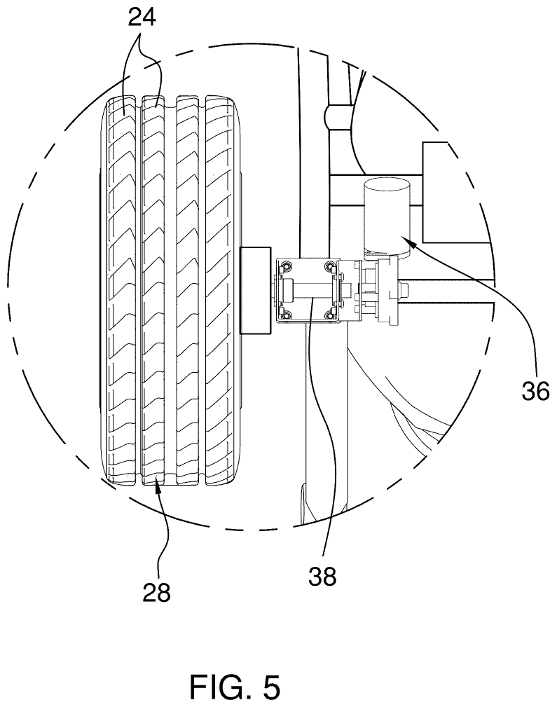

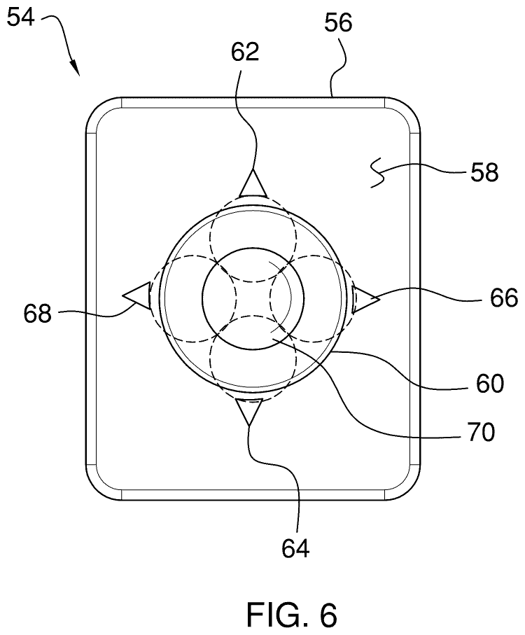

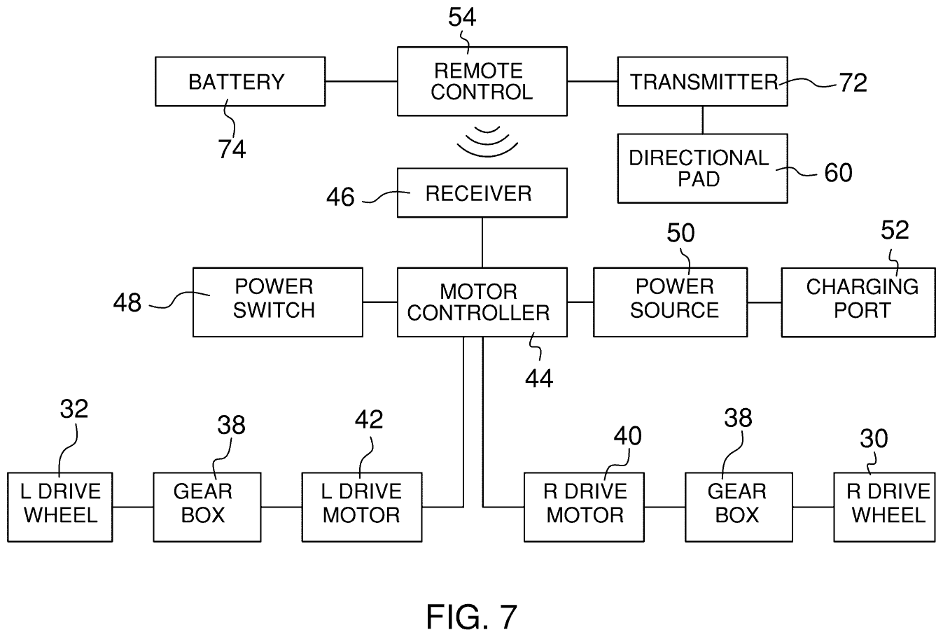

With reference now to the drawings, and in particular to FIGS. 1 through 9 thereof, a new stroller embodying the principles and concepts of an embodiment of the disclosure and generally designated by the reference numeral 10 will be described.

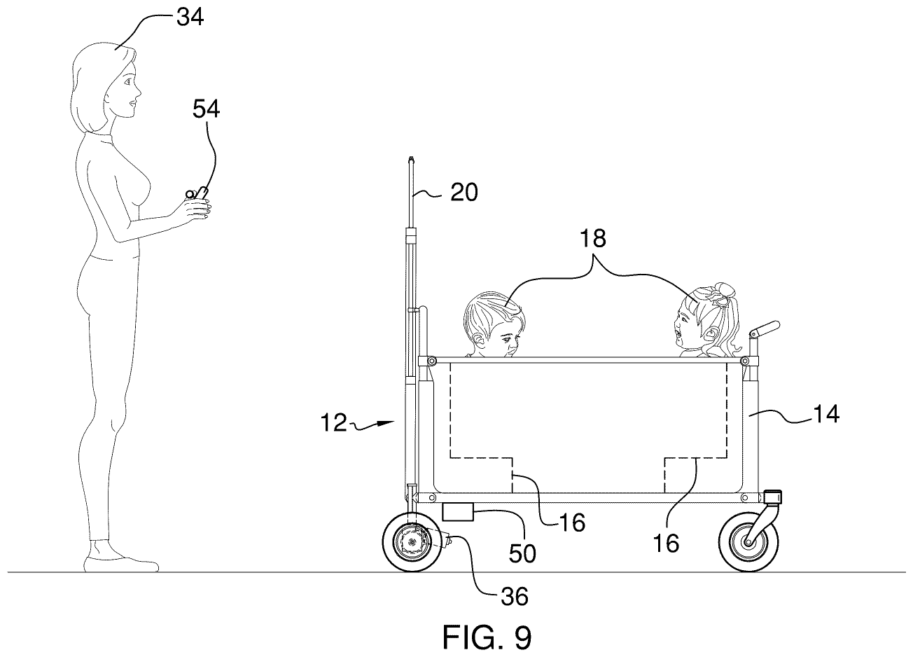

As best illustrated in FIGS. 1 through 9, the motorized stroller device 10 generally comprises a carriage 12 that has a frame 14 and a seat 16 is coupled to the frame 14. The carriage 12 is generally configured to support and facilitate transportation of a passenger 18, such as a child, a toddler, or an infant. The passenger 18 may also be a pet, such as a dog or a cat. For example, the carriage 12 may be a stroller or a wagon. As shown in FIG. 9, the seat 16 may be one of a plurality of seats 16 wherein the carriage 12 is configured to support a plurality of passengers 18. A handle 20 may be coupled to the carriage 12. For example, the handle 20 may extend upwardly from the frame 14 to facilitate movement of the carriage 12.

A plurality of wheels 22 are rotatably coupled to the frame 14 to facilitate movement of the carriage 12. In some embodiments, each wheel of the plurality of wheels 22 may be an all-terrain wheel wherein each wheel of the plurality of wheels 22 has an interlocking tread 24 that is positioned on an exterior surface. The interlocking tread 24 is generally configured to facilitate movement of the carriage 12 across a plurality of surfaces such as dirt, gravel, grass, sand, or pavement.

The plurality of wheels 22 generally includes a pair of front wheels 28. The pair of front wheels 28 may be pivotably coupled to the frame 14. Pivoting the pair of front wheels 28 facilitates adjustment of a direction in which the carriage 12 is moved. For example, each front wheel of the pair of front wheels 28 may pivot to the right to facilitate movement of the carriage 12 to the right, and each front wheel of the pair of front wheels 28 may pivot to the left to facilitate movement of the carriage 12 to the left.

A pair of rear wheels 28 is spaced from the pair of front wheels 28. For example, the pair of rear wheels 28 may be positioned proximate to the handle 20. Each rear wheel of the pair of rear wheels 28 may have a width that exceeds a width of each front wheel of the pair of front wheels 28. In alternative embodiments, each rear wheel of the pair of rear wheels 28 may have a width that is equal to a width of each front wheel of the pair of front wheels 28.

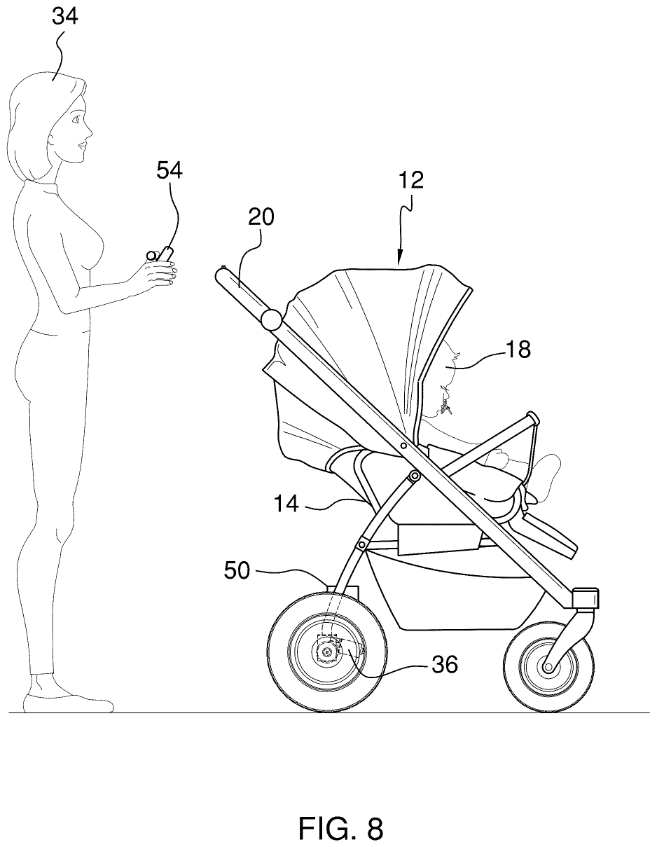

More specifically, the pair of rear wheels 28 generally includes a right rear wheel 30 that is positioned on a right side of the frame 14. The right side of the frame 14 is generally configured to be positionable adjacent to a right side of a user 34 while the user 34 is facing the carriage 12 from behind the pair of rear wheels 28, as shown in FIGS. 8 and 9. A left rear wheel 32 is positioned on a left side of the frame 14. The left side of the frame 14 is generally configured to be positionable adjacent to a left side of the user 34 while the user 34 is facing the carriage 12 from behind the pair of rear wheels 28.

The motorized stroller device 10 further comprises a pair of electric motors 36. Each electric motor of the pair of electric motors 36 includes a respective drive shaft 38. Each electric motor of the pair of electric motors 36 is actuatable to rotate the respective drive shaft 38. The respective drive shaft 38 is operatively coupled to a respective rear wheel of the pair of rear wheels 28 to selectively rotate the respective rear wheel of the pair of rear wheels 28. More specifically, the pair of electric motors 36 may include a right electric motor 40 that is operatively coupled to the right rear wheel 30 of the pair of rear wheels 28. A left electric motor 42 is generally operatively coupled to the left rear wheel 32 of the pair of rear wheels 28.

A processor 44 is in communication with the pair of electric motors 36. Actuation of the processor 44 actuates at least one electric motor of the pair of electric motors 36. A receiver 46 is electrically coupled to the processor 44. The receiver 46 receives wireless signals for actuating the processor 44.

A switch 48 may be in communication with the receiver 46. The switch 48 is actuatable to selectively turn the receiver 46 on and off. The receiver 46 is inhibited receiving wireless signals while the receiver 46 is turned off. The switch 48 may be positioned on the handle 20.

A power source 50 may be electrically coupled to the processor 44. The power source 50 may be a battery, and the battery may be rechargeable. The power source 50 may be mounted to the frame 14 proximate to the pair of rear wheels 28 of the plurality of wheels 22. A charging port 52 may be electrically coupled to the power source 50. The charging port 52 may be inset into the power source 50. The charging port 52 may be exposed within the power source 50.

A remote control 54 is in communication with the receiver 46. For example, the remote control 54 may be in wireless communication with the receiver 46. In another example, the remote control 54 may be electrically coupled to the receiver 46 via a hardwired connection. The remote control 54 can be used to actuate each electric motor of the pair of electric motors 36 in a first direction, a second direction, and a stationary condition.

Each electric motor of the pair of electric motors 36 may rotate the respective rear wheel of the pair of rear wheels 28 in the first direction while each electric motor of the pair of electric motors 36 is actuated in the first direction. Each electric motor of the pair of electric motors 36 may rotate the respective rear wheel of the pair of rear wheels 28 in the second direction while each electric motor of the pair of electric motors 36 is actuated in the second direction. Each electric motor of the pair of electric motors 36 may cease rotation of the respective rear wheel of the pair of rear wheels 28 while each electric motor of the pair of electric motors 36 is actuated in the stationary condition. In other words, actuation of both electric motors of the pair of electric motors 36 in the stationary condition may stop the movement of the carriage 12.

For example, actuating each electric motor of the pair of electric motors 36 in the stationary condition may gradually decrease a level of voltage delivered to each electric motor of the pair of electric motors 36, gradually slowing each electric motor of the pair of electric motors 36, which in turn gradually slows rotation of the pair of rear wheels 28 and movement of the carriage 12. Alternatively, movement of the carriage 12 may be stopped by reversing the direction in which each electric motor of the pair of electric motors 36 is being rotated for a short time before the processor 44 stops delivering voltage to the pair of electric motors 36. For example, the processor 44 may change from actuating of each electric motor of the pair of electric motors 36 in the first direction to actuating of each electric motor of the pair of electric motors 36 in the second direction, causing each electric motor of the pair of electric motors 36 to quickly change the direction in which each rear wheel of the pair of rear wheels 28 is rotated. Reversing the direction of rotation of the pair of electric motors 36 can slow down movement of the carriage 12 before each electric motor of the pair of electric motors 36 is actuated in the stationary condition to fully stop movement of the carriage 12.

The remote control 54 may include a housing 56 with a front surface 58. The housing 56 may have a size that is configured to facilitate a user 34 in operating the remote control 54 using a single hand. For example, the housing 56 may have a size that is approximately equal to, or less than, a telephone or a television remote such that the user 34 can hold and operate the remote control 54 with the same hand.

A directional pad 60 is selectively positionable in a forward direction, a reverse direction, a right direction, a left direction, and a home position wherein the directional pad 60 is selectively positionable to control the direction in which the carriage 12 is moved. The home position may be centered between each of the forward direction, the reverse direction, the right direction, and the left direction. The directional pad 60 may be configured to return to the home position when the user 34 is not positioning the directional pad 60 into one of the forward direction, the reverse direction, the right direction, and the left direction. In other words, the directional pad 60 may return to the home position when the user 34 is not exerting pressure on the directional pad 60 to position the directional pad 60 in one of the forward direction, the reverse direction, the right direction, and the left direction. The directional pad 60 may be positioned on the front surface 58 of the housing 56 wherein the directional pad 60 is configured to be accessible to the user 34 while the user 34 is holding the housing 56 in the single hand.

In certain embodiments, the directional pad 60 may be a joystick that is pivotably coupled to the housing 56. The joystick may be pivotable in 360 degrees around an axis of rotation centered on the joystick to facilitate the direction of movement of the carriage 12 in 360 degrees. In other words, some embodiments of the directional pad 60 may facilitate input to control the direction of movement in discreet specific directions, namely, the forward direction, the reverse direction, the right direction, and the left direction. Conversely, embodiments wherein the directional pad 60 is a joystick may facilitate more inputs, allowing the user 34 to control the direction of movement of the carriage 12 in any direction within the range of motion of the joystick. Such embodiments may allow analog control of the direction in which the carriage 12 is moved, providing greater movement flexibility.

A transmitter 72 is electrically coupled to the directional pad 60. The transmitter 72 generally sends wireless signals from the remote control 54 to the receiver 46 to actuate each electric motor of the pair of electric motors 36 in an associated one of the first direction, the second direction, and the stationary condition, depending on the respective position of the directional pad 60.

More specifically, the transmitter 72 may send wireless signals to the receiver 46 to actuate both electric motors of the pair of electric motors 36 in the first direction while the directional pad 60 is positioned in the forward direction. Actuation of both electric motors of the pair of electric motors 36 in the first direction urges the carriage 12 forward relative to the pair of front wheels 28. For example, the first direction may be clockwise wherein actuation of both electric motors of the pair of electric motors 36 rotates both rear wheels of the pair of rear wheels 28 clockwise, urging the carriage 12 forward.

The transmitter 72 may send wireless signals to the receiver 46 to actuate both electric motors of the pair of electric motors 36 in the second direction while the directional pad 60 is positioned in the reverse direction. Actuation of both electric motors of the pair of electric motors 36 in the second direction may urge the carriage 12 backward relative to the pair of front wheels 28. For example, the second direction may be counterclockwise wherein actuation of both electric motors of the pair of electric motors 36 rotates both rear wheels of the pair of rear wheels 28 counterclockwise, urging the carriage 12 backward.

The transmitter 72 may send wireless signals to the receiver 46 to actuate the left electric motor 42 of the pair of electric motors 36 in the first direction and the right electric motor 40 of the pair of electric motors 36 in the stationary condition while the directional pad 60 is pivoted in the right direction. Actuation of the left electric motor 42 in the first direction while the right electric motor 40 is actuated in the stationary condition may turn the carriage 12 to toward the right rear wheel 30. In other words, moving the directional pad 60 to the right direction is configured to turn the carriage 12 to the right of the user 34 while the user 34 is standing behind the pair of rear wheels 28. In some alternative embodiments, the transmitter 72 may send wireless signals to the receiver 46 to actuate the left electric motor 42 in the first direction and the right electric motor 40 in the second direction to turn the carriage 12 to the right.

The transmitter 72 may send wireless signals to the receiver 46 to actuate the left electric motor 42 in the stationary condition and the right electric motor 40 in the first direction while the directional pad 60 is pivoted in the left direction. Actuation of the left electric motor 42 in the stationary condition and actuation of the right electric motor 40 in the first direction may turn the carriage 12 toward the left rear wheel 32. In other words, moving the directional pad 60 to the left direction is configured to turn the carriage 12 to the left of the user 34 while the user 34 is standing behind the pair of rear wheels 28. In some alternative embodiments, the transmitter 72 may send wireless signals to the receiver 46 to actuate the left electric motor 42 in the second direction and the right electric motor 40 in the first direction to turn the carriage 12 to the left.

The transmitter 72 may send wireless signals to the receiver 46 to actuate both electric motors of the pair of electric motors 36 in the stationary condition while the directional pad 60 is in the home position, stopping movement of the carriage 12 as described above. In some alternative embodiments, the transmitter 72 may send wireless signals to the receiver 46 to reverse the direction in which both electric motors of the pair of electric motors 36 are actuated when the directional pad 60 is in the home position. In other words, moving the directional pad 60 into the home position while the pair of electric motors 36 are actuated in the first direction may signal the transmitter 72 to send wireless signals to the receiver 46 to actuate both electric motors of the pair of electric motors 36 in the second direction for a short time to slow and stop the carriage 12, as described above.

A battery 74 may be positioned within the housing 56. The battery 74 is generally electrically coupled to the transmitter 72. In alternative embodiments, for example when the remote control 54 communicates with the receiver 46 via a wired connection instead of a wireless connection, the remote control 54 may be powered by the power source 50 that is electrically coupled to the processor 44.

In use, the remote control 54 can be used to actuate the pair of motors to move the carriage 12 forward, backward, to the right, and to the left. The user 34 does not need to physically push the carriage 12. Instead, the user 34 can simply hold the remote control 54 and use the directional pad 60 to control the direction in which the carriage 12 is moved. The remote control 54 may wirelessly communicate with the receiver 46 to selectively actuate each electric motor of the pair of electric motors 36. In other embodiments, the remote control 54 may be electrically coupled to the receiver 46 via a hardwired connection.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A buggy assembly comprising:
a carriage having a frame and a seat;
a plurality of wheels being rotatably coupled to the frame to facilitate movement of the carriage, the plurality of wheels including:
a pair of front wheels; and
a pair of rear wheels;
a pair of electric motors, each electric motor of the pair of electric motors being operatively coupled to a respective rear wheel of the pair of rear wheels to selectively rotate the respective rear wheel of the pair of rear wheels;
a processor being in communication with the pair of electric motors;
a receiver being in communication with the processor;
a remote control being in communication with the receiver to selectively actuate the pair of electric motors in a first direction, a second direction, and a stationary condition, the remote control including:
a directional pad being selectively positionable in a forward direction, a reverse direction, a right direction, a left direction, and a home position to control a direction in which the carriage is being moved;
a transmitter being in communication with the directional pad wherein the transmitter sends wireless signals from the remote control to the receiver to actuate each electric motor of the pair of electric motors in an associated one of the first direction, the second direction, and the stationary condition.

2. The buggy assembly of claim 1, wherein each wheel of the plurality of wheels is an all-terrain wheel wherein each wheel of the plurality of wheels has an interlocking tread being positioned on an exterior surface, the interlocking tread being configured to facilitate movement of the carriage across a plurality of surfaces.

3. The buggy assembly of claim 1, wherein the seat is one of a plurality of seats wherein the carriage is configured to support a plurality of passengers.

4. The buggy assembly of claim 1, wherein the pair of front wheels are pivotably coupled to the frame wherein pivoting the pair of front wheels facilitates adjustment of the direction in which the carriage is being moved.

5. The buggy assembly of claim 1, wherein each rear wheel of the pair of rear wheels has a width exceeding a width of each front wheel of the pair of front wheels.

6. The buggy assembly of claim 1, further comprising a switch being in communication with the receiver, the switch being actuatable to selectively turn the receiver on and off.

7. The buggy assembly of claim 1, wherein the home position of the directional pad is centered between each of the forward direction, the reverse direction, the right direction, and the left direction.

8. The buggy assembly of claim 7, wherein the directional pad is configured to return to the home position when a user is not positioning the directional pad into one of the forward direction, the reverse direction, the right direction, and the left direction.

9. The buggy assembly of claim 1, wherein the transmitter sends wireless signals to the receiver to actuate both electric motors of the pair of electric motors in the first direction while the directional pad is positioned in the forward direction wherein actuation of both electric motors of the pair of electric motors in the first direction urges the carriage forward relative to the pair of front wheels.

10. The buggy assembly of claim 1, wherein the transmitter sends wireless signals to the receiver to actuate both electric motors of the pair of electric motors in the second direction while the directional pad is positioned in the reverse direction wherein actuation of both electric motors of the pair of electric motors in the second direction urges the carriage backward relative to the pair of front wheels.

11. The buggy assembly of claim 1, wherein the transmitter sends wireless signals to the receiver to actuate the left electric motor of the pair of electric motors in the first direction and the right electric motor of the pair of electric motors in the stationary condition while the directional pad is pivoted in the right direction wherein actuation of the left electric motor in the first direction and actuation of the right electric motor in the stationary condition turns the carriage toward the right direction.

12. The buggy assembly of claim 1, wherein the transmitter sends wireless signals to the receiver to actuate the left electric motor of the pair of electric motors in the first direction and the right electric motor of the pair of electric motors in the second direction while the directional pad is pivoted in the right direction wherein actuation of the left electric motor in the first direction and actuation of the right electric motor in the second direction turns the carriage toward the right direction.

13. The buggy assembly of claim 1, wherein the transmitter sends wireless signals to the receiver to actuate the left electric motor of the pair of electric motors in the stationary condition and the right electric motor of the pair of electric motors in the first direction while the directional pad is pivoted in the left direction wherein actuation of the left electric motor in the stationary condition and actuation of the right electric motor in the first direction turns the carriage toward the left direction.

14. The buggy assembly of claim 1, wherein the transmitter sends wireless signals to the receiver to actuate the left electric motor of the pair of electric motors in the second direction and the right electric motor of the pair of electric motors in the first direction while the directional pad is pivoted in the left direction wherein actuation of the right electric motor in the first direction and actuation of the left electric motor in the stationary condition turns the carriage toward the left direction.

15. The buggy assembly of claim 1, wherein the transmitter sends wireless signals to the receiver to actuate both electric motors of the pair of electric motors in the stationary condition while the directional pad is in the home position.

16. A buggy assembly comprising:
a carriage having a frame and a seat being coupled to the frame wherein the carriage is configured to support a passenger, the seat being one of a plurality of seats wherein the carriage is configured to support a plurality of passengers;
a handle being coupled to the carriage, the handle extending upwardly from the frame to facilitate movement of the carriage;
a plurality of wheels being rotatably coupled to the frame to facilitate movement of the carriage, each wheel of the plurality of wheels being an all-terrain wheel wherein each wheel of the plurality of wheels has an interlocking tread being positioned on an exterior surface, the interlocking tread being configured to facilitate movement of the carriage across a plurality of surfaces, the plurality of wheels including:
a pair of front wheels, the pair of front wheels being pivotably coupled to the frame wherein pivoting the pair of front wheels adjusts a direction in which the carriage is being moved; and
a pair of rear wheels being spaced from the pair of front wheels, the pair of rear wheels being positioned proximate to the handle, each rear wheel of the pair of rear wheels having a width exceeding a width of each front wheel of the pair of front wheels, the pair of rear wheels including:
a right rear wheel being positioned on a right side of the frame, the right side of the frame being configured to be positioned adjacent to a right side of a user while the user is facing the carriage from behind the pair of rear wheels; and
a left rear wheel being positioned on a left side of the frame, the left side of the frame being configured to be positioned adjacent to a left side of the user while the user is facing the carriage from behind the pair of rear wheels;
a pair of electric motors, each electric motor including a respective drive shaft, the respective drive shaft being operatively coupled to a respective rear wheel of the pair of rear wheels to selectively rotate the respective rear wheel of the pair of rear wheels, the pair of electric motors including:
a right electric motor being operatively coupled to the right rear wheel of the pair of rear wheels; and
a left electric motor being operatively coupled to the left rear wheel of the pair of rear wheels;
a processor being in communication with the pair of electric motors wherein actuation of the processor actuates at least one electric motor of the pair of electric motors;
a receiver being electrically coupled to the processor wherein the receiver receives wireless signals for actuating the processor;
a switch being in communication with the receiver, the switch being actuatable to selectively turn the receiver on and off wherein the receiver is inhibited from sending and receiving wireless signals while the receiver is turned off;
a power source being electrically coupled to the processor, the power source being a battery, the battery being rechargeable, the power source being mounted to the frame proximate to the pair of rear wheels of the plurality of wheels;
a charging port being electrically coupled to the power source, the charging port being inset into the power source, the charging port being exposed within the power source;
a remote control being in wireless communication with the receiver to selectively actuate each electric motor of the pair of electric motors in a first direction, a second direction, and a stationary condition, each electric motor of the pair of electric motors rotating the respective rear wheel of the pair of rear wheels in the first direction while each electric motor of the pair of electric motors is actuated in the first direction, each electric motor of the pair of electric motors rotating the respective rear wheel of the pair of rear wheels in the second direction while each electric motor of the pair of electric motors is actuated in the second direction, each electric motor of the pair of electric motors ceasing rotation of the respective rear wheel of the pair of rear wheels while each electric motor of the pair of electric motors is actuated in the stationary condition wherein actuation of both electric motors of the pair of electric motors in the stationary condition stops movement of the carriage, the remote control including:
a housing having a front surface, the housing having a size being configured to facilitate a user in operating the remote control using a single hand;
a directional pad being selectively positionable in a forward direction, a reverse direction, a right direction, a left direction, and a home position to control the direction in which the carriage is being moved, the home position being centered between each of the forward direction, the reverse direction, the right direction, and the left direction, the directional pad being configured to return to the home position when the user is not positioning the directional pad into one of the forward direction, the reverse direction, the right direction, and the left direction, the directional pad being positioned on the front surface of the housing wherein the directional pad is configured to be accessible to the user while the user is holding the housing in the single hand, the directional pad being a joystick being pivotably coupled to the housing;
a transmitter being electrically coupled to the directional pad wherein the transmitter sends wireless signals from the remote control to the receiver to actuate each electric motor of the pair of electric motors in an associated one of the first direction, the second direction, and the stationary condition, the transmitter sending wireless signals to the receiver to actuate both electric motors of the pair of electric motors in the first direction while the directional pad is positioned in the forward direction wherein actuation of both electric motors of the pair of electric motors in the first direction urges the carriage forward relative to the pair of front wheels, the transmitter sending wireless signals to the receiver to actuate both electric motors of the pair of electric motors in the second direction while the directional pad is positioned in the reverse direction wherein actuation of both electric motors of the pair of electric motors in the second direction urges the carriage backward relative to the pair of front wheels, the transmitter sending wireless signals to the receiver to actuate the left electric motor of the pair of electric motors in the first direction and the right electric motor of the pair of electric motors in the stationary condition while the directional pad is pivoted in the right direction wherein actuation of the left electric motor in the first direction and actuation of the right electric motor in the stationary condition turns the carriage toward the right rear wheel, the transmitter sending wireless signals to the receiver to actuate the left electric motor of the pair of electric motors in the stationary condition and the right electric motor of the pair of electric motors in the first direction while the directional pad is pivoted in the left direction wherein actuation of the left electric motor in the stationary condition and actuation of the right electric motor in the first direction turns the carriage toward the left rear wheel, the transmitter sending wireless signals to the receiver to actuate both electric motors of the pair of electric motors in the stationary condition while the directional pad is in the home position;
a battery being positioned within the housing, the battery being electrically coupled to the transmitter.
